(19) United States
(12) Patent Application Publication
(10) Pub. No.: US 2017/0108906 A1
(43) Pub. Date: Apr. 20, 2017

(54) Single Fuel Gauge for Multiple Energy Storage Devices

(71) Applicant: Microsoft Technology Licensing, LLC, Redmond, WA (US)

(72) Inventors: Ranveer Chandra, Bellevue, WA (US); Anirudh Badam, Issaquah, WA (US); Jonathan Alan Dutra, Saratoga, CA (US); Julia L. Meinershagen, Seattle, WA (US); Stephen E. Hodges, Cambridge (GB); Nissanka Arachchige Bodhi Priyantha, Redmond, WA (US)

(21) Appl. No.: 14/885,858

(22) Filed: Oct. 16, 2015

(51) Int. Cl. G06F 1/28; G06F 1/32

(52) U.S. Cl. CPC G06F 1/28; G06F 1/3203

(57) ABSTRACT

A multiple energy storage device fuel gauge is described for a device having a power system with multiple heterogeneous energy storage devices. The fuel gauge keeps track of a present state of multiple heterogeneous energy storage devices simultaneously. The fuel gauge implements collective measurement of voltage and current of the multiple heterogeneous energy storage devices via shared circuitry to determine status information, such as state of charge (SOC) and internal resistance values. A controller of the fuel gauge uses various measurements and energy storage device-specific parameters to compute status values indicative of the state of each energy storage device. The status values are maintained by the fuel gauge and exposed to other system components to facilitate power management decisions. A communication bus is used to communicate between the fuel gauge and system components, and a software API may be exposed to facilitate access to various energy storage device specific information.

### BACKGROUND

Mobile computing devices have been developed to increase the functionality that is made available to users in a mobile setting. For example, a user may interact with a mobile phone, tablet computer, or other mobile computing device to check email, surf the web, compose texts, interact with applications, and so on. One challenge that faces developers of mobile computing devices is efficient power management and extension of battery life. Achieving a long battery life under given physical size and weight constraints is a critical goal for mobile devices such as mobile phones and tablets. Various power management strategies may be applied to control processor and battery utilization generally at the expense of overall device performance. If power management implemented for a device fails to strike a good balance between performance and battery life, user dissatisfaction with the device and manufacturer may result.

### SUMMARY

A multiple energy storage device fuel gauge is described for a device having a power system with multiple heterogeneous energy storage devices. The fuel gauge keeps track of the present state of two or more heterogeneous energy storage devices simultaneously. The fuel gauge implements collective measurement of voltage and current of the multiple energy storage devices via shared circuitry to determine status information such as state of charge (SOC). A controller of the fuel gauge uses various measurements and energy storage device-specific parameters to compute status values indicative of the state of each energy storage device. The status values for each energy storage device, such as SOC, are maintained by the fuel gauge and exposed to other power subsystem modules and/or system components to facilitate power management decisions. A communication bus is used to communicate between the fuel gauge and system components, and a software API may be exposed to facilitate access to various energy storage device specific information.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 illustrates an example operating environment in accordance with one or more implementations.

FIG. 2 is diagram depicting example details of a computing device having an energy storage system with heterogeneous energy storage devices in accordance with one or more implementations.

FIG. 3 illustrates an example user interface displaying status information of a power system with heterogeneous energy storage devices in accordance with one or more implementations.

FIG. 4 is diagram depicting details of a system having heterogeneous energy storage devices in accordance with one or more implementations.

FIG. 5 is a flow diagram that describes details of an example procedure for updating status information of heterogeneous energy storage devices in accordance with one or more implementations.

FIG. 6 is a flow diagram that describes details of an example procedure for measuring and computing status values relating to heterogeneous energy storage devices in accordance with one or more implementations.

FIG. 7 is a block diagram of a system that can include or make use of a fuel gauge for heterogeneous energy storage devices in accordance with one or more implementations.

### DETAILED DESCRIPTION

Overview

Typically, a fuel gauge for a computing device is implemented to keep track of the status of a single energy storage device. In a multi-energy storage device architecture, implementing a separate fuel gauge for each of the multiple energy storage devices can lead to increased component count, increased bill of material, and compromised reliability. Further, multiple fuel gauges can result in reduced coordination and increased communication overhead.

A multiple energy storage device fuel gauge is described for a device having an energy storage system with heterogeneous energy storage devices. The heterogeneous energy storage devices may include devices having various different characteristics such as energy storage devices of different sizes, capacities, battery technologies, chemistries, shapes, state of charge (SOC) and so forth. The multiple energy storage device fuel gauge is configured to collectively measure voltages of the multiple heterogeneous energy storage devices using common measuring circuitry and use the measurement to determine energy storage device status information, such as state of charge values. The multiple energy storage device fuel gauge is also configured to collectively measure current going into and out of the multiple energy storage devices to update SOC, keep track of charge-discharge cycle count, and use the measured voltage and current to compute or estimate the internal resistance of each of the multiple energy storage devices. A controller of the multiple energy storage device fuel gauge uses various measurements and energy storage device specific parameters to determine the state of each energy storage device. Energy storage device specific parameters are programmed into the controller during manufacture or during a system configuration phase to enable handling of different energy storage devices having a diverse set of characteristics. Techniques and computations used to derive status information may vary for different energy storage devices and cells based on the different characteristics and technologies. Accordingly, the energy storage device specific parameters are used to estimate the status of each energy storage device in a heterogeneous group based on measured values, such as voltage, current, and cycle count. The status information of each energy storage device is maintained by the fuel gauge to and exposed to facilitate power management decisions by the power subsystem modules, the CPU, the OS, applications, and so forth. A communication bus facilitates communication between the fuel gauge and the rest of the system, and a software API may exposed to facilitate access to various information relating to specific energy storage devices.

A multiple energy storage device fuel gauge as described herein enables monitoring of the status values of multiple individual energy storage devices, including SOC values, cycle counts, and estimated capacity for each of the energy storage devices and for the energy storage system as a whole. Rather than implementing a fuel gauge for each of the energy storage devices individually, a single fuel gauge for multiple energy storage devices provides shared measuring circuitry that reduces the total component count resulting in a reduced bill of material and improved reliability. Additionally, a multiple energy storage device fuel gauge provides a single point of communication for obtaining energy storage device status information which results in reduced coordination and communication overhead compared to multiple fuel gauges connected together by a communication bus.

In the discussion that follows, a section titled “Operating Environment” is provided and describes one example environment in which one or more implementations can be employed. Following this, a section titled “Multiple-Energy Storage Device Fuel Gauge” describes example details and procedures in accordance with one or more implementations. Last, a section titled “Example System” describes example computing systems, components, and devices that can be utilized for one or more implementations of a multiple-energy storage device fuel gauge.

Operating Environment

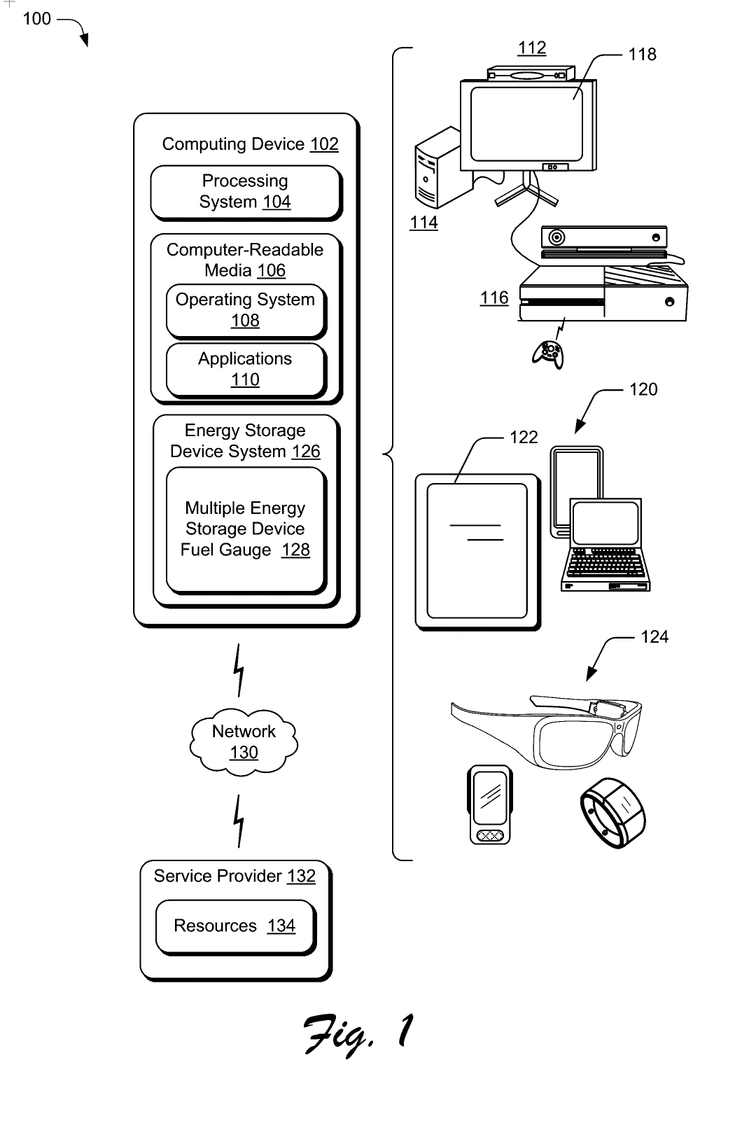

FIG. 1 illustrates an operating environment in accordance with one or more embodiments, generally at 100. The environment 100 includes a computing device 102 having a processing system 104 with one or more processors and devices (e.g., CPUs, GPUs, microcontrollers, hardware elements, fixed logic devices, etc.), one or more computer-readable media 106, an operating system 108, and one or more applications 110 that reside on the computer-readable media and which are executable by the processing system. The processing system 104 may be configured to include multiple independent processors configured in parallel or in series and one or more multi-core processing units. A multi-core processing unit may have two or more processors (“cores”) included on the same chip or integrated circuit. In one or more implementations, the processing system 104 may include multiple processing cores that provide a range of performance capabilities, processing efficiencies, and power usage characteristics.

The processing system 104 may retrieve and execute computer-program instructions from applications 110 to provide a wide range of functionality to the computing device 102, including but not limited to gaming, office productivity, email, media management, printing, networking, web-browsing, and so forth. A variety of data and program files related to the applications 110 can also be included, examples of which include games files, office documents, multimedia files, emails, data files, web pages, user profile and/or preference data, and so forth.

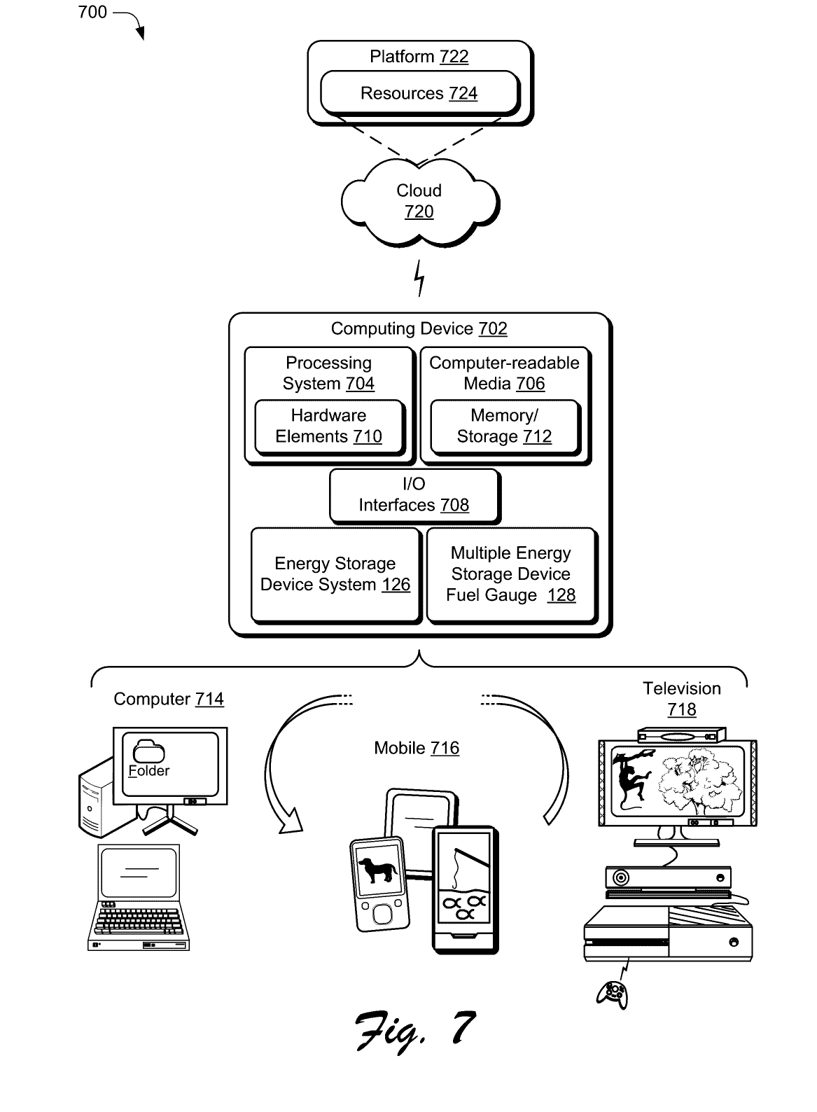

The computing device 102 can be embodied as any suitable computing system and/or device such as, by way of example and not limitation, a gaming system, a desktop computer, a portable computer, a tablet or slate computer, a handheld computer such as a personal digital assistant (PDA), a cell phone, a set-top box, a wearable device (e.g., watch, band, glasses, etc.), and the like. For example, as shown in FIG. 1, the computing device 102 can be implemented as a television client device 112, a computer 114, and/or a gaming system 116 that is connected to a display device 118 to display media content. Alternatively, the computing device may be any type of portable computer, mobile phone, or portable device 120 that includes an integrated display 122. A computing device may also be configured as a wearable device 124 that is designed to be worn by, attached to, carried by, or otherwise transported by a user. Examples of wearable devices 124 depicted in FIG. 1 include glasses, a smart band or watch, and a pod device such as a clip-on fitness device, media player, or tracker. Other examples of wearable devices 124 include but are not limited to badges, a key fob, an access card, and a ring, an article of clothing, a glove, or a bracelet, to name a few examples. Any of the computing devices can be implemented with various components, such as one or more processors and memory devices, as well as with any combination of differing components. One example of a computing system that can represent various systems and/or devices including the computing device 102 is shown and described below in relation to FIG. 7.

The computer-readable media can include, by way of example and not limitation, all forms of volatile and non-volatile memory and/or storage media that are typically associated with a computing device. Such media can include ROM, RAM, flash memory, hard disk, removable media and the like. Computer-readable media can include both “computer-readable storage media” and “communication media,” examples of which can be found in the discussion of the example computing system of FIG. 7.

The computing device 102 may also include an energy storage device system 126 and a multiple energy storage device fuel gauge 128 that operate as described above and below. The energy storage device system 126 is configured to include multiple heterogeneous energy storage devices as discussed in greater detail below. The energy storage device system and the multiple energy storage device fuel gauge 128 may be provided using any suitable combination of hardware, software, firmware, and/or logic devices. As illustrated, the energy storage device system 126 and the multiple energy storage device fuel gauge 128 may be configured as modules or devices separate from the operating system and other components. In addition or alternatively, the multiple energy storage device fuel gauge 128 may also be configured as a module that is combined with the operating system 108 or implemented via a controller, logic device or other component of the energy storage device system 126 as illustrated.

The multiple energy storage device fuel gauge 128, also referred to as “fuel gauge” 128, represents functionality operable to collectively track the status of two or more energy storage devices of the energy storage device system 126. In one or more implementations, the fuel gauge 128 may be configured to compute status values based on SOC estimation parameters for each of the multiple energy storage devices and data corresponding to a measured voltage and/or current of the multiple energy storage devices. The SOC estimation parameters may include, but are not limited to, energy storage device characteristics such as energy storage device chemistries and energy storage device physical features. The values computed by fuel gauge 128 may be used to update status information and status values corresponding to each of the energy storage devices, such as SOC, cycle count, internal resistance, and estimated capacity. The status information may then be communicated via a shared communication channel to the operating system 108 and/or other system components. Details regarding these and other aspects of a multiple energy storage device fuel gauge are discussed in the following section.

The environment 100 further depicts that the computing device 102 may be communicatively coupled via a network 130 to a service provider 132, which enables the computing device 102 to access and interact with various resources 134 made available by the service provider 132. The resources 134 can include any suitable combination of content and/or services typically made available over a network by one or more service providers. For instance, content can include various combinations of text, video, ads, audio, multi-media streams, applications, animations, images, webpages, and the like. Some examples of services include, but are not limited to, an online computing service (e.g., “cloud” computing), an authentication service, web-based applications, a file storage and collaboration service, a search service, messaging services such as email and/or instant messaging, and a social networking service.

Having described an example operating environment, consider now example details and techniques associated with one or more implementations of a multiple energy storage device fuel gauge.

Multiple Energy Storage Device Fuel Gauge Details

To further illustrate, consider the discussion in this section of example devices, components, procedures, and implementation details that may be utilized to provide a multiple energy storage device fuel gauge as described herein. In general, functionality, features, and concepts described in relation to the examples above and below may be employed in the context of the example procedures described in this section. Further, functionality, features, and concepts described in relation to different figures and examples in this document may be interchanged among one another and are not limited to implementation in the context of a particular figure or procedure. Moreover, blocks associated with different representative procedures and corresponding figures herein may be applied together and/or combined in different ways. Thus, individual functionality, features, and concepts described in relation to different example environments, devices, components, figures, and procedures herein may be used in any suitable combinations and are not limited to the particular combinations represented by the enumerated examples in this description.

Example Device

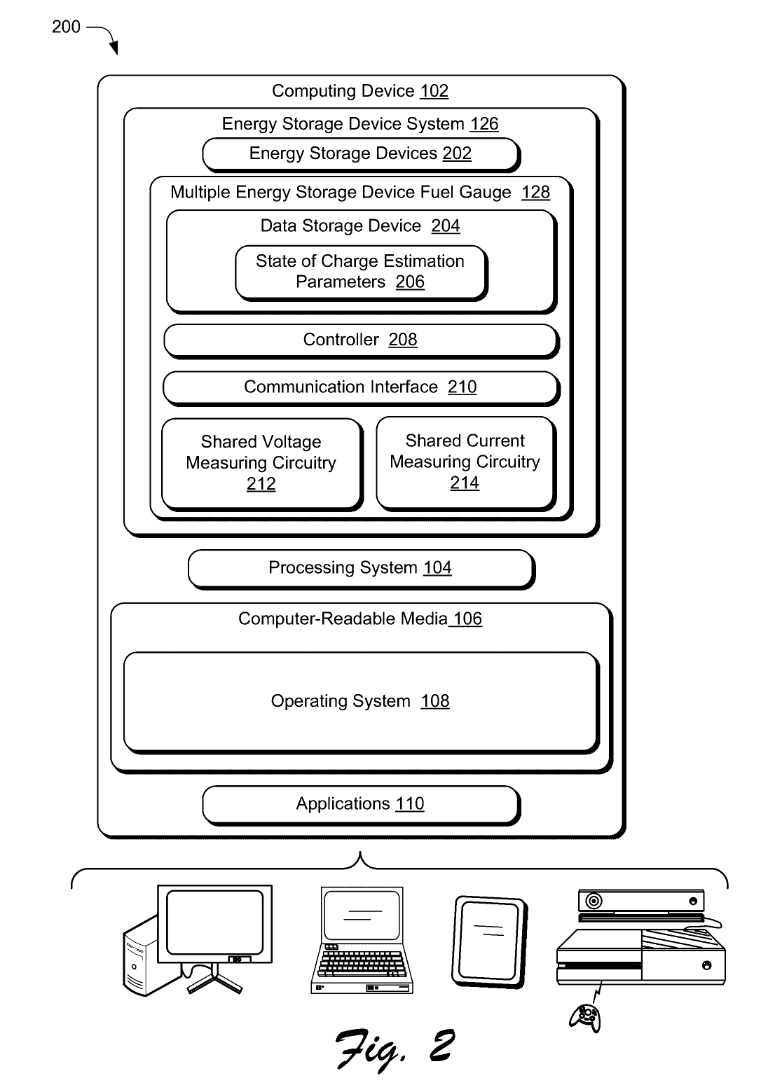

FIG. 2 generally at 200 depicts example details of a computing device 102 having an energy storage device system 126 with heterogeneous energy storage devices in accordance with one or more implementations. Computing device 102 also includes processing system 104, computer-readable media 106, operating system 108, and applications 110 as discussed in relation to FIG. 1. In the depicted example, a multiple energy storage device fuel gauge 128 is also shown as being implemented as a component of the energy storage device system 126. Fuel gauge 128 may be implemented as a separate standalone integrated circuit, or combined with another integrated circuit such a power management integrated circuit (PMIC), energy storage device charging controller, or some other integrated circuit.

By way of example and not limitation, the energy storage device system 126 is depicted as having energy storage devices 202, which are representative of various different kinds of energy storage devices that may be included with the computing device, such as batteries. As mentioned, energy storage devices 202 include devices having different characteristics such as different sizes, capacities, chemistries, battery technologies, shapes, SOC, discharge rates, ages, discharge curves, and so forth. Accordingly, the energy storage device system 126 includes a diverse combination of multiple energy storage devices at least some of which have different characteristics, one to another. Various combinations of energy storage devices 202 may be utilized to provide a range of capacities, performance capabilities, efficiencies, and power usage characteristics that may be mapped to different end usage scenarios. Using different types of energy storage devices provides flexibility for design of the energy storage system and circuit boards, and consequently enables device developers to make better utilization of internal space to provide devices having increased battery life and efficiency.

Data storage device 204 is representative of functionality to store state of charge (SOC) estimation parameters 206 and/or other data related to one or more of the energy storage devices 202. SOC estimation parameters 206 can be programmed into the fuel gauge 128 during manufacture, or during a system configuration. Alternatively or additionally, SOC estimation parameters 206 can be programmed through an application programming interface (API) exposed to enable interaction and communication with the fuel gauge 128 over a communication bus. The SOC estimation parameters may include, but are not limited to, energy storage device characteristics such as energy storage device chemistries, energy storage device physical features, thermal conditions, user presence, processor/core utilization, application context, device context, priority, location of energy storage devices within the computing device, location of energy storage devices external to the computing device, specified capacity of the energy storage devices, self-discharge rates of the energy storage devices, aging of the energy storage devices, and discharge curves associated with the energy storage devices.

The controller 208 is representative of functionality to use various measurements and SOC estimation parameters 206 to determine the state of the energy storage devices 202. The controller 208 can be implemented as a single microcontroller or a single sequential logic circuit. Alternatively or additionally, controller 208 may be comprised of multiple microcontrollers or sequential logic circuits, or any suitable means for determining the state of the energy storage devices 202. The controller 208 is further configured to monitor measured voltage, current, and charging/discharging events of energy storage devices 202 to determine energy storage device status such as SOC, internal resistance, and aging-compensated capacity. While SOC, internal resistance, and aging-compensated capacity are described here, one skilled in the art will appreciate that other indicators of status are also contemplated, which are determinable using the obtained measurements and the SOC estimation parameters 206 in the described manner. The controller 208 can then provide updated status information relating to the energy storage devices 202 as measurements are obtained.

In one or more implementations, the fuel gauge 128 further includes a communication interface 210 which is representative of functionality to interface with the rest of the power management subsystem, the OS, and the CPU through a communication bus. The communication bus may take the form of a serial bus or an 12C bus; however, other embodiments are also contemplated. The fuel gauge 128, if implemented as a standalone device, may be capable of communicating with the OS and other components through a software API via the communication bus, allowing the status of energy storage devices 202 to accessed and utilized. As mentioned previously, conventional fuel gauges operate according to a per-energy storage device scenario. In other words, each energy storage device of a computing device has its own fuel gauge. Such per-energy storage device configurations can result in extra system hardware complexity due to extra wires and connections in the circuit board to support the multiple fuel gauges, as well as additional communication and software overhead for a handling enumeration of and communications with the multiple fuel gauges. On the other hand, multiple energy storage device fuel gauge 128 as described herein utilized shared circuitry and a single communication end point, thereby reducing the system hardware and software overheads.

In various implementations, fuel gauge 128 is configured to include shared measuring circuitry to obtain data regarding status of multiple energy storage devices/cells. As represented, shared measuring circuitry can include shared voltage measuring circuitry 212 and shared current measuring circuitry 214. Through the shared measuring circuitry, terminal voltage of attached energy storage devices may be obtained to determine state of the energy storage device, such as SOC and internal resistance of the particular energy storage device. The fuel gauge 128 implements sharing of voltage measurement circuitry 212 among multiple energy storage devices 202, as opposed to conventional means which use dedicated circuitry per energy storage device. In one approach, measuring terminal voltage of multiple energy storage devices 202 is accomplished by multiplexing the voltage measurement circuits, such as by time-multiplexing. In this approach, the fuel gauge 128 may include a shared multiplexer device.

Similarly, the fuel gauge 128 may periodically measure the current flowing into or out of energy storage devices 202 using current measuring circuitry 214 in order to determine the SOC and internal resistance of energy storage devices 202. The magnitude and direction of the current can be used to update energy storage device SOC as well as to keep track of energy storage device charge/discharge cycle count. A shared cycle counter maybe provided to accumulate and track the cycle counts for the multiple energy storage devices. Current measuring circuitry 214 may also be capable of activating safety features under unexpected load conditions. Further, fuel gauge 128 can share current measuring circuitry 214 among multiple energy storage devices 202 by multiplexing the current measurement circuits, such as by time-multiplexing.

Example Fuel Gauge User Interface

Generally speaking, energy storage device system 126 having multiple heterogeneous energy storage devices may be configured in various ways and employ a variety of different types of energy storage devices. Information relating to SOC and other status values for multiple energy storage devices may be presented to users in various way to allow the users to better understand how a device uses power from multiple energy storage devices and adjust power management setting and policies accordingly . . .

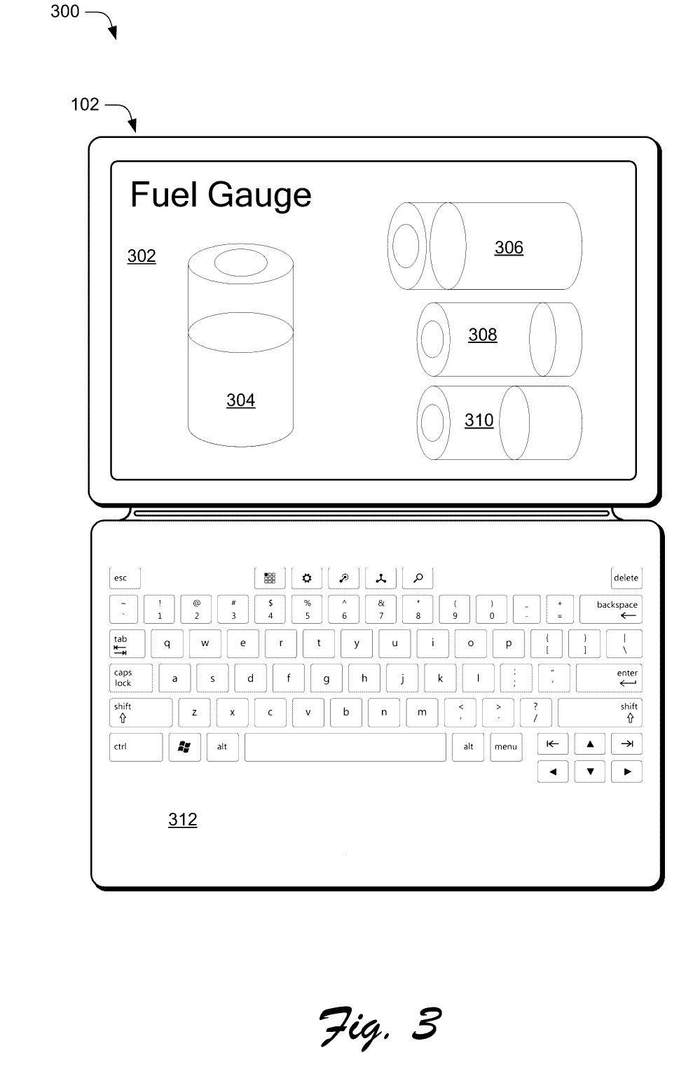

In particular, FIG. 3 depicts generally at 300 one illustrative example of a power management user interface 302 displayed at computing device 102. User interface 302 may comprise representations 304, 306, 308, and 310 configured to indicate at least SOC information for respective energy storage devices 202. Other data and status information regarding the energy storage devices may also be exposed via the representations, such as device descriptions, cycle counts, aging data, usage statistics, and so forth. While four representations of respective energy storage devices are depicted in this example, any number of representations of any number of corresponding energy storage devices is contemplated for display in user interface 302.

The user interface 302 may be configured in any suitable way to convey SOC information and other information regarding the energy storage devices to users. For example, the user interface 302 in the example of FIG. 3 includes energy storage device representation 304, which corresponds to an overall status of SOC of all energy storage devices 202. While a representation of an energy storage device is pictured, other representations are also contemplated to indicate overall SOC in user interface 302, such as a numerical representation (percentage, fraction, etc.), graphs, charts, textual descriptions, a list view, or other graphical representations, pictures and/or shapes. Representation 304 may alternatively correspond to a selected subset or grouping of all of the energy storage devices 202 of computing device 102. A subset of energy storage devices 202 to be represented by representation 304 may be configured by any suitable means, such as by a user of the device or by default settings of computing device 102. In one approach, the subset corresponds to energy storage devices that are presently being used to service the load for the computing device. Subsets may also correspond to different properties such as device type, size, technology employed, and so forth. Furthermore, the energy storage devices 202 which are represented by the representation 304 (and other representations) may change over time, as different energy storage devices 202 are added, removed, and/or are not currently providing power to computing device 102.

The user interface 302 may further include energy storage device representations 306, 308, and 310, which each correspond to separate, individual energy storage devices. Again, while three instances of energy storage device representations are provided, any number of representations of separate energy storage devices is contemplated. While the different example representations are illustrated in FIG. 3 as being exposed on a common screen or page, the user interface 302 may be configured to have multiple different pages, tabs, and/or portions designed to expose different views corresponding to different devices, parameters, and collection of information regarding the energy storage device system. The user interface may provide representations for some or all of the storage devices associated with computing device 102 using different pages, views, portions and UI instrumentalities.

By way of example and not limitation, energy storage device representation 304 can be configured to display an overall SOC for computing device 102. Meanwhile, energy storage device representation 306 can display a SOC for a subset of energy storage devices, such as external energy storage devices stored in an external device 312. In this example, representations 308 and 310 may represent multiple heterogeneous energy storage devices located within the computing device 102. A variety of other examples and configurations of a user interface 302 suitable to display SOC representations to provide status information to a user are also contemplated.

Example Power Management Integrated Circuitry

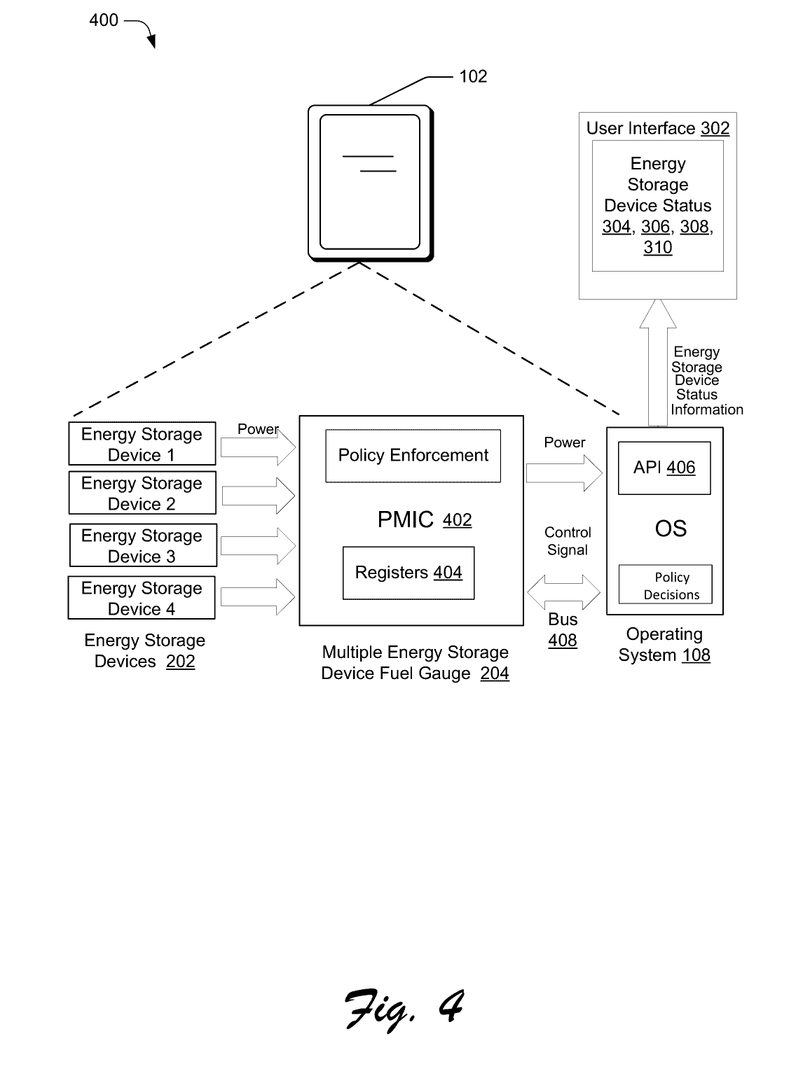

FIG. 4 depicts generally at 400 example details of a system having heterogeneous energy storage devices in accordance with one or more implementations. In particular, the example of FIG. 4 depicts a system having energy storage devices 202 that may be integrated with a computing device 102. Power is supplied via the energy storage devices using techniques discussed herein. In the depicted example, fuel gauge 128 is implemented via a power management integrated circuit (PMIC) 402 that is adapted to support measuring voltage and current, computing values based on SOC estimation parameters and measured voltage and current, and update status information corresponding to energy storage devices. In one or more implementations, the PMIC or other energy storage device controller is adapted to include registers 404 to facilitate policy enforcement relating to fuel gauge 128. The registers 404 represent hardware registers, storage devices, and/or memory devices implemented using any suitable technology and configured to hold various parameters, such as SOC estimation parameters 206, that the PMIC 402 makes use of when computing values for energy storage device status information updates. Registers may be assigned default values selected for general usage in typical scenarios, which may be set at manufacturing time or set during a configuration phase of computing device 102. Registers may then be selectively adapted under the influence of the operating system and/or user input to implement policy settings for different use cases.

The registers 404 implemented by the energy storage device controller are exposed to enable operating system 108 and/or application 110 level control over SOC estimation parameters 206. In other words, the registers 404 can provide user-accessible control over heterogeneous energy storage device SOC estimation parameters via operating system functionality and/or applications. By way of example and not limitation, parameter values for the registers 404 may be set and updated dynamically via an application programming interface (API) 406 that is exposed by the operating system 108 as represented in FIG. 4. API messages and/or other control signals may be exchanged between the PMIC 402 and operating system 108 over a suitable communication bus 408, one example of which is an I2C bus. Information regarding states of energy storage devices, workload, and characteristics of energy storage devices 202 may also be communicated to the operating system 108 and/or energy storage device system 126 via the control signals and/or API to facilitate assessments of the operational context and policy decisions based on the operational context.

Thus, as represented in FIG. 4, the operating system 108, by way of energy storage device system 126 or otherwise, may make policy decisions such as mode selection, energy storage device constraints, and alterations to SOC estimation parameters 206. Policy decisions can be made based on performance parameters indicative of an operational context, including at least information regarding energy storage device status obtained from the PMIC 402. Alternatively or additionally, policy decisions can be made based on information received from other computing devices, or may be based on system updates containing updates for SOC estimation parameters 206. The API 406 provides a mechanism by which control signals are communicated to the PMIC 402 to implement policy enforcement of a selected policy by setting the registers 404 and causing operation of hardware to effectuate the constraints specified by the policy. Power is then supplied to the system via one or more of the energy storage devices in accordance with the policy decisions.

Operating system 108 is further configured to output a user interface 302 configured to display energy storage device status representations 304, 306, 308, and 310 using energy storage device status information obtained from API 406. As described above in relation to FIG. 3, a number of configurations for display of energy storage device representations are contemplated. Details regarding these and other aspects of multiple energy storage device fuel gauges are described in relation the following example procedures.

Example Procedures

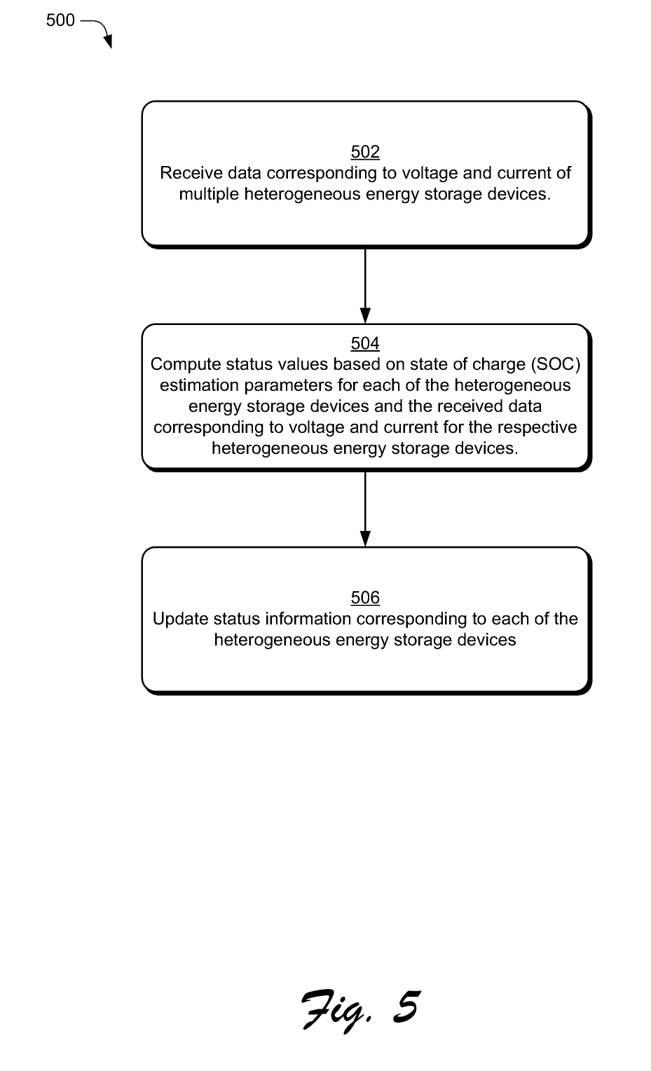

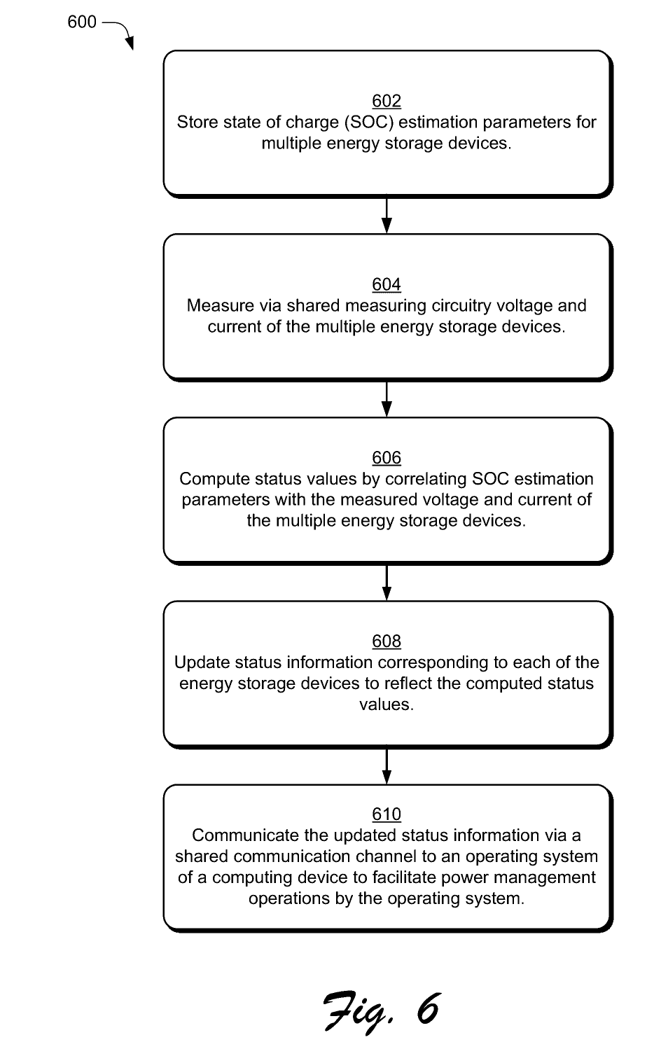

This section discusses additional aspects of a multiple energy storage device fuel gauge in relation to example procedures of FIG. 5 and FIG. 6. The procedures described in this document may be implemented utilizing the environment, system, devices, and components described herein and in connection with any suitable hardware, software, firmware, or combination thereof The procedures are represented as a set of blocks that specify operations performed by one or more entities and are not necessarily limited to the orders shown for performing the operations by the respective blocks.

FIG. 5 is a flow diagram which describes details of an example procedure 500 for updating status information corresponding to multiple heterogeneous energy storage devices in accordance with one or more implementations. The procedure 500 can be implemented by way of a suitably configured computing device, such as by way of operating system 108, controller 208 or PMIC 402 (e.g., a power management controller) and/or other functionality described in relation to the examples of FIGS. 1-4. Individual operations and details discussed in relation to procedure 500 may also be combined in various ways with operations and details discussed herein in relation to the example procedure of FIG. 6.

Data corresponding to voltage and current of multiple heterogeneous energy storage devices is received (block 502). As noted, a computing device 102 having two or more heterogeneous energy storage devices 202 may include a multiple energy storage device fuel gauge 128 designed with shared measuring circuitry connected to the two or more heterogeneous energy storage devices. The shared measuring circuitry enables collective measurement to be made for a system of diverse energy storage device, such as batteries or battery cells with different shapes, capacities, ages, cycle counts, and so forth. Shared circuitry may include but is not limited to a shared controller, multiplexer, connectors, voltage measuring devices, current measuring devices, and a cycle counter, to name a few examples. Thus, the multiple energy storage device fuel gauge is able to collect data regarding a present state of the system of energy storage devices. In some implementations, the raw collected data is communicated to and received by an operating system or other application configured to analyze and process the data to derive status information. In addition or alternatively, a controller of the multiple energy storage device fuel gauge may receive the data and perform at least some computations and correlations to derive status values indicative of the states of the various energy storage devices including in the system. In any case, the measure values are correlated in some way to SOC estimation parameters 206 to arrive at updated status information

In this context, data corresponding to terminal voltage of the energy storage devices may be received that is measured via measuring circuitry of a suitably configured controller or device, examples of which are described above and below. The measuring circuitry may be configured to consolidate the received data for multiple energy storage devices by time-multiplexing. Additionally, the measuring circuitry may be further configured to obtain data corresponding to current going into and out of the multiple energy storage devices, magnitude and direction of the current, and data relating to charge/discharge cycle count. Such data may also be consolidated for multiple energy storage devices by time-multiplexing. Cycle counts, aging indications, and other relevant values may also be measured.

Then, status values are computed based on SOC estimation parameters for each of the heterogeneous energy storage devices and the data received in step 502 corresponding to voltage and current for the respective heterogeneous energy storage devices (block 504). As described above, SOC estimation parameters 206 may include, but are not limited to, energy storage device characteristics such as energy storage device chemistries, energy storage device physical features, thermal conditions, user presence, processor/core utilization, application context, device context, priority, location of energy storage devices within the computing device, location of energy storage devices external to the computing device, specified capacity of the energy storage devices, self-discharge rates of the energy storage devices, aging of the energy storage devices, and discharge curves associated with the energy storage devices. The fuel gauge may include hardware registers, flash memory, or other suitable storage/memory suitable to maintain the SOC estimation parameters. Parameters may also be obtained by and/or stored the OS to facilitate computations of status values by the OS and/or other applications.

To derive status values for the heterogeneous energy storage devices, the SOC estimation parameters are correlated to the received data. For example, stored parameters may be included in a look-up table, curve data, database or other suitable data structure suitable to map status values to measured conditions of the energy storage devices. In this case, a pre-computed reference library of status values is available that accounts for different algorithms and correlations that may exist for different types of energy storage devices, characteristics of the devices, and operating conditions. Here, the collected data is correlated by matching the data to appropriate pre-computed information in the reference library.

In addition or alternatively, the correlation involves computing status values “on-demand” using appropriate performance curves, formulas, and algorithms for each energy storage device. In this scenario, a library of device-specific computations is maintained that is relied upon to compute status values based on the received data and relevant SOC estimation parameters used in the device-specific computations.

Correlations using pre-computed libraries or “on-demand” computations may be performed by the operating system in communication with the fuel gauge. In addition or alternatively, the fuel gauge may be configured to perform the correlations directly and then convey or otherwise expose status values and updated status information for use by the operating system, applications, and/or other system components.

Status information corresponding to each of the energy storage devices is updated with the status values as computed (block 506). To do so, the measured values such as voltage, current, and cycle count are used in combination with SOC estimation parameters to estimate the status of each energy storage device, such as SOC and aging-compensated capacity, in the manner just described. When responsible for handling the computations, the operating system 108 may operate to update a table, database, file, hardware register or other suitable data structure based to reflect the status values. Alternatively, a multiple energy storage device fuel gauge, such as fuel gauge 128, can include a controller to take various measurements and update status information for multiple energy storage devices, within a register 404 and/or other suitable data structure through interactions with the OS and other system components In general, the updating of status information across the computing system occurs through operations of the operating system 108 in communication with hardware of the computing device that implements the multiple energy storage device fuel gauge, such as a controller 208, PMIC 402 or other single microcontroller of integrated circuit that operates as a fuel gauge 204.

Once updated status information is obtained, the status information may be used in various ways to facilitate power management operations and policy decisions. This may include but is not limited to determinations regarding charging and discharging, usage of the energy storage devices, selection of one or a combination of energy storage devices to enable or disable, implementations of energy conservation strategies, power mode selections, notifications and alerts, and so forth. In one or more implementations, status information for the multiple heterogeneous energy storage devices is exposed via an application programming interface (API) to facilitate power management actions based on the one or more status values. Applications and other system components of the computing device may access and utilize the status information via the API. For example, a power manager module provided by the operating system (or otherwise) may reference the status values to make and enforce power management policy decisions. In another example, a user interface to display status information, such as the example user interface 302 of FIG. 3. may be configured, presented, and refreshed based upon status information exposed via the API (or otherwise). Other components of the computing device that may access and rely upon status information include, by way of example and not limitation a CPU controller, a graphics system, a display driver, and/or other components of a power management subsystem.

FIG. 6 is a flow diagram which describes details of an example procedure 600 for updating status information corresponding to multiple heterogeneous energy storage devices in accordance with one or more implementations. The procedure 600 can be implemented by way of a suitably configured computing device, such as by way of an energy storage device system 126 having a fuel gauge 128, and/or other functionality described in relation to the examples of FIGS. 1-4. Individual operations and details discussed in relation to procedure 600 may also be combined in various ways with operations and details discussed herein in relation to the example procedure of FIG. 5.

State of charge (SOC) estimation parameters are stored for multiple energy storage devices (block 602). Examples of SOC estimation parameters that may be employed for the techniques described herein have been provided above. The SOC estimation parameters may be preset during manufacturing or during a configuration phase. Updates for SOC estimation parameters may alternatively or additionally be provided from an operating system or other source for storage by a fuel gauge using hardware registers or other suitable memory/storage devices, as described in relation to FIG. 4. In this manner, parameters used to compute the status values may be dynamically updated over time, which improves the accuracy of the computations. For example, updated performance curves, cycle count correlation, and other parameter may be derived after a product has been used for a period of time. These updates may be used to update initial values used for the product that have proven to be less accurate.

Voltage and current of the multiple energy storage devices are measured via shared measuring circuitry of a multiple energy storage device fuel gauge (block 604). As noted previously, a computing device 102 may include a fuel gauge 128 as described herein that uses shared circuitry to monitor a set of diverse energy storage devices. Shared circuitry may include shared voltage measuring circuitry that is shared among multiple energy storage devices and provides measurements relating to terminal voltage via time-multiplexing. Similarly, shared circuitry may include shared current measuring circuitry that is shared among multiple energy storage devices and provides measurements relating to magnitude and direction of current and cycle count via time-multiplexing. Additional examples of shared circuitry include a shared multiplexer and cycle count devices.

Status values are computed by correlating estimation parameters with the measured voltage and current of the multiple energy storage devices (block 606). Status values can be correlated in any suitable way, examples of which are provided above. For instance, the correlation can occur using pre-computed libraries and/or on-demand computations as described above to derive various status values for each energy storage device. The status values can include but are not limited to SOC values, such as a percent of charge, time of charge remaining, total power available, and so forth.

Status information corresponding to each of the energy storage devices is updated to reflect the computed status values (block 608). As noted, energy storage status information may include, but is not limited to, SOC values, cycle counts, and estimated capacities corresponding to a particular energy storage device. Additionally, status value totals may be computed and updated for energy storage devices as a collective whole, or for different subsets and grouping of the energy storage devices. Subsets or groupings may be formed based on shared characteristics of the energy storage devices, such as type, size, technology, age, and/or other factors.

Updated status information is communicated via a shared communication channel to an operating system of a computing device to facilitate power management operations by the operating system (block 610). Such communication may take place through a communication bus such as a serial bus or 12C bus capable of communication between controller 208 and the operating system, via a power management subsystem, or otherwise. Thus, various status information regarding the system as a whole and individual energy storage devices may be obtained and used in different ways to drive power management decisions. This includes exposing various views of the status information via a suitably configured user interface. This additionally includes directing operation of a PMIC and/or other power management components to control a system of heterogeneous energy storage devices based in part upon the status information that is obtained. For instance, charging and discharging and mode of operation for a system of heterogeneous energy storage devices may be controlled in accordance with status information that is gathered from a fuel gauge 128 as described in this document.

Having described example details and procedures associated with multiple energy storage device fuel gauges, consider now a discussion of an example system that can include or make use of a fuel gauge for heterogeneous energy storage devices in accordance with one or more implementations.

Example System

FIG. 7 illustrates an example system 700 that includes an example computing device 702 that is representative of one or more computing systems and/or devices that may implement the various techniques described herein. The computing device 702 may be, for example, a server of a service provider, a device associated with a client (e.g., a client device), an on-chip system, and/or any other suitable computing device or computing system.

The example computing device 702 as illustrated includes a processing system 704, one or more computer-readable media 706, and one or more I/O interfaces 708 that are communicatively coupled, one to another. Although not shown, the computing device 702 may further include a system bus or other data and command transfer system that couples the various components, one to another. A system bus can include any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

The processing system 704 is representative of functionality to perform one or more operations using hardware. Accordingly, the processing system 704 is illustrated as including hardware elements 710 that may be configured as processors, functional blocks, and so forth. This may include implementation in hardware as an application specific integrated circuit or other logic device formed using one or more semiconductors. The hardware elements 710 are not limited by the materials from which they are formed or the processing mechanisms employed therein. For example, processors may be comprised of semiconductor(s) and/or transistors (e.g., electronic integrated circuits (ICs)). In such a context, processor-executable instructions may be electronically-executable instructions.

The computer-readable media 706 is illustrated as including memory/storage 712. The memory/storage 712 represents memory/storage capacity associated with one or more computer-readable media. The memory/storage 712 may include volatile media (such as random access memory (RAM)) and/or nonvolatile media (such as read only memory (ROM), Flash memory, optical disks, magnetic disks, and so forth). The memory/storage 712 may include fixed media (e.g., RAM, ROM, a fixed hard drive, and so on) as well as removable media (e.g., Flash memory, a removable hard drive, an optical disc, and so forth). The computer-readable media 706 may be configured in a variety of other ways as further described below.

Input/output interface(s) 708 are representative of functionality to allow a user to enter commands and information to computing device 702, and also allow information to be presented to the user and/or other components or devices using various input/output devices. Examples of input devices include a keyboard, a cursor control device (e.g., a mouse), a microphone for voice operations, a scanner, touch functionality (e.g., capacitive or other sensors that are configured to detect physical touch), a camera (e.g., which may employ visible or non-visible wavelengths such as infrared frequencies to detect movement that does not involve touch as gestures), and so forth. Examples of output devices include a display device (e.g., a monitor or projector), speakers, a printer, a network card, tactile-response device, and so forth. Thus, the computing device 702 may be configured in a variety of ways as further described below to support user interaction.

Various techniques may be described herein in the general context of software, hardware elements, or program modules. Generally, such modules include routines, programs, objects, elements, components, data structures, and so forth that perform particular tasks or implement particular abstract data types. The terms “module,” “functionality,” and “component” as used herein generally represent software, firmware, hardware, or a combination thereof. The features of the techniques described herein are platform-independent, meaning that the techniques may be implemented on a variety of commercial computing platforms having a variety of processors.

An implementation of the described modules and techniques may be stored on or transmitted across some form of computer-readable media. The computer-readable media may include a variety of media that may be accessed by the computing device 702. By way of example, and not limitation, computer-readable media may include “computer-readable storage media” and “communication media.”

“Computer-readable storage media” refers to media and/or devices that enable storage of information in contrast to mere signal transmission, carrier waves, or signals per se. Thus, computer-readable storage media does not include signal bearing media, transitory signals, or signals per se. The computer-readable storage media includes hardware such as volatile and non-volatile, removable and non-removable media and/or storage devices implemented in a method or technology suitable for storage of information such as computer readable instructions, data structures, program modules, logic elements/circuits, or other data. Examples of computer-readable storage media may include, but are not limited to, RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and which may be accessed by a computer.

“Communication media” may refer to signal-bearing media that is configured to transmit instructions to the hardware of the computing device 702, such as via a network. Communication media typically may embody computer readable instructions, data structures, program modules, or other data in a modulated data signal, such as carrier waves, data signals, or other transport mechanism. Communication media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media.

As previously described, hardware elements 710 and computer-readable media 806 are representative of instructions, modules, programmable device logic and/or fixed device logic implemented in a hardware form that may be employed in some embodiments to implement at least some aspects of the techniques described herein. Hardware elements may include components of an integrated circuit or on-chip system, an application-specific integrated circuit (ASIC), a field-programmable gate array (FPGA), a complex programmable logic device (CPLD), and other implementations in silicon or other hardware devices. In this context, a hardware element may operate as a processing device that performs program tasks defined by instructions, modules, and/or logic embodied by the hardware element as well as a hardware device utilized to store instructions for execution, e.g., the computer-readable storage media described previously.

Combinations of the foregoing may also be employed to implement various techniques and modules described herein. Accordingly, software, hardware, or program modules including the operating system 108, applications 110, multiple energy storage device fuel gauge 128, and other program modules may be implemented as one or more instructions and/or logic embodied on some form of computer-readable storage media and/or by one or more hardware elements 710. The computing device 702 may be configured to implement particular instructions and/or functions corresponding to the software and/or hardware modules. Accordingly, implementation of modules as a module that is executable by the computing device 702 as software may be achieved at least partially in hardware, e.g., through use of computer-readable storage media and/or hardware elements 710 of the processing system. The instructions and/or functions may be executable/operable by one or more articles of manufacture (for example, one or more computing devices 702 and/or processing systems 704) to implement techniques, modules, and examples described herein.

As further illustrated in FIG. 7, the example system 700 enables ubiquitous environments for a seamless user experience when running applications on a personal computer (PC), a television device, and/or a mobile device. Services and applications run substantially similar in all three environments for a common user experience when transitioning from one device to the next while utilizing an application, playing a video game, watching a video, and so on.

In the example system 700, multiple devices are interconnected through a central computing device. The central computing device may be local to the multiple devices or may be located remotely from the multiple devices. In one embodiment, the central computing device may be a cloud of one or more server computers that are connected to the multiple devices through a network, the Internet, or other data communication link.

In one embodiment, this interconnection architecture enables functionality to be delivered across multiple devices to provide a common and seamless experience to a user of the multiple devices. Each of the multiple devices may have different physical requirements and capabilities, and the central computing device uses a platform to enable the delivery of an experience to the device that is both tailored to the device and yet common to all devices. In one embodiment, a class of target devices is created and experiences are tailored to the generic class of devices. A class of devices may be defined by physical features, types of usage, or other common characteristics of the devices.

In various implementations, the computing device 702 may assume a variety of different configurations, such as for computer 714, mobile 716, and television 718 uses. Each of these configurations includes devices that may have generally different constructs and capabilities, and thus the computing device 702 may be configured according to one or more of the different device classes. For instance, the computing device 702 may be implemented as the computer 714 class of a device that includes a personal computer, desktop computer, a multi-screen computer, laptop computer, netbook, and so on.

The computing device 702 may also be implemented as the mobile 716 class of device that includes mobile devices, such as a mobile phone, portable music player, portable gaming device, a tablet computer, a multi-screen computer, and so on. The computing device 702 may also be implemented as the television 718 class of device that includes devices having or connected to generally larger screens in casual viewing environments. These devices include televisions, set-top boxes, gaming consoles, and so on.

The techniques described herein may be supported by these various configurations of the computing device 702 and are not limited to the specific examples of the techniques described herein. This is illustrated through inclusion of the multiple energy storage device fuel gauge 128 on the computing device 702. The functionality represented by multiple energy storage device fuel gauge 128 and other modules/applications may also be implemented all or in part through use of a distributed system, such as over a “cloud” 720 via a platform 722 as described below.

The cloud 720 includes and/or is representative of a platform 722 for resources 724. The platform 722 abstracts underlying functionality of hardware (e.g., servers) and software resources of the cloud 720. The resources 724 may include applications and/or data that can be utilized while computer processing is executed on servers that are remote from the computing device 702. Resources 724 can also include services provided over the Internet and/or through a subscriber network, such as a cellular or Wi-Fi network.

The platform 722 may abstract resources and functions to connect the computing device 702 with other computing devices. The platform 722 may also serve to abstract scaling of resources to provide a corresponding level of scale to encountered demand for the resources 724 that are implemented via the platform 722. Accordingly, in an interconnected device embodiment, implementation of functionality described herein may be distributed throughout the system 700. For example, the functionality may be implemented in part on the computing device 702 as well as via the platform 722 that abstracts the functionality of the cloud 720.

Example Implementations

Example implementations of techniques described herein include, but are not limited to, one or any combinations of one or more of the following examples:

### EXAMPLE 1

A device powered at least in part by energy storage devices, the device comprising: two or more heterogeneous energy storage devices; a fuel gauge attached to the two or more energy storage devices, the fuel gauge including: storage to maintain state of charge (SOC) estimation parameters for each of the energy storage devices attached to the fuel gauge, each of the SOC estimation parameters corresponding to characteristics of the respective energy storage devices; a controller connected via shared circuitry to each of the energy storage devices attached to the fuel gauge, the controller operable to: measure values indicative of a status of each of the energy storage devices attached to the fuel gauge; and update status information corresponding to each of the energy storage devices attached to the fuel gauge based on the measured values and the SOC estimation parameters.

### EXAMPLE 2

The device as described in any one or more of the examples in this section, wherein the controller of the fuel gauge includes shared voltage measuring circuitry configured to periodically measure the terminal voltage of the attached energy storage devices by time multiplexing.

### EXAMPLE 3

The device as described in any one or more of the examples in this section, wherein the controller of the fuel gauge includes shared current measurement circuitry configured to periodically measure current flowing into or out of the attached energy storage devices by time multiplexing.

### EXAMPLE 4

The device as described in any one or more of the examples in this section, wherein the controller is a single microcontroller.

### EXAMPLE 5

The device as described in any one or more of the examples in this section, wherein the controller is a single sequential logic circuit.

### EXAMPLE 6

The device as described in any one or more of the examples in this section, wherein the fuel gauge includes a communication interface operable to communicate the status information to a power management system of the device.

### EXAMPLE 7

The device as described in any one or more of the examples in this section, wherein the power management system is operable to output a user interface containing the status information of the power management system, the user interface configured to expose combined status for the two or more energy storage devices and individual statuses of the two or more energy storage devices.

### EXAMPLE 8

The device as described in any one or more of the examples in this section, wherein the characteristics of the respective energy storage devices include energy storage device chemistries and physical features of the respective energy storage devices.

### EXAMPLE 9

The device as described in any one or more of the examples in this section, wherein the status information comprises a SOC value, cycle count, estimated internal resistance, and estimated capacity of each of the energy storage devices attached to the fuel gauge.

### EXAMPLE 10

The device as described in any one or more of the examples in this section, wherein the fuel gauge is configured to receive updates of SOC estimation parameters from an operating system of the computing device.

### EXAMPLE 11

A method implemented by a computing device having two or more heterogeneous energy storage devices and a multiple energy storage device fuel gauge designed with shared measuring circuitry connected to the two or more heterogeneous energy storage devices, the method comprising: receiving data measured via the shared measuring circuitry of the multiple energy storage device fuel gauge corresponding to at least voltage and current of the two or more heterogeneous energy storage devices; computing one or more status values based on state of charge (SOC) estimation parameters for each of the heterogeneous energy storage devices and the received data corresponding to voltage and current of the two or more heterogeneous energy storage devices, the SOC estimation parameters corresponding to characteristics of the respective heterogeneous energy storage devices that are correlated to the received data to derive the one or more status values; and updating status information corresponding to each of the heterogeneous energy storage devices with the one or more status values as computed.

### EXAMPLE 12

The method as described in any one or more of the examples in this section, wherein receiving the data comprises receiving voltage data measured via shared voltage measuring circuitry of the multiple energy storage device fuel gauge configured to periodically measure the terminal voltage of the attached heterogeneous energy storage devices by time multiplexing.

### EXAMPLE 13

The method as described in any one or more of the examples in this section, wherein receiving the data comprises receiving current data measured via shared current measurement circuitry of the multiple energy storage device fuel gauge configured to periodically measure current flowing into or out of the attached heterogeneous energy storage devices by time multiplexing.

### EXAMPLE 14

The method as described in any one or more of the examples in this section, further comprising receiving data measured via the shared measuring circuitry of the multiple energy storage device fuel gauge corresponding to a number of executed charging events and discharging events of the respective heterogeneous energy storage devices.

### EXAMPLE 15

The method as described in any one or more of the examples in this section, wherein the status information comprises SOC values, internal resistance, and aging compensated capacity for each of the heterogeneous energy storage devices.

### EXAMPLE 16

The method as described in any one or more of the examples in this section, wherein the receiving, computing, and updating are performed by an operating system executed by the computing device in communication with a single microcontroller of the computing device that implements the multiple energy storage device fuel gauge.

### EXAMPLE 17

The method as described in any one or more of the examples in this section, further comprising exposing the status information for the multiple heterogeneous energy storage devices to other components of the computing device via an application programming interface (API) to facilitate power management actions based on the one or more status values.

### EXAMPLE 18

A method implemented by a power management controller of a computing device that includes a multiple energy storage device fuel gauge, the method comprising: storing state of charge (SOC) estimation parameters for two or more heterogeneous energy storage devices, each of the SOC estimation parameters corresponding to characteristics of the respective heterogeneous energy storage devices; measuring via shared measuring circuitry of the multiple energy storage device fuel gauge at least voltage and current of the two or more heterogeneous energy storage devices; computing status values by correlating the SOC estimation parameters with the measured voltage and current of the two or more heterogeneous energy storage devices to derive status values including at least a SOC for each energy storage device and internal resistance for each energy storage device based on measured voltage and current values; updating status information corresponding to each of the heterogeneous energy storage devices to reflect the computed status values; and communicating the updated status information via a shared communication channel to an operating system of the computing device to facilitate power management operations by the operating system.

### EXAMPLE 19

The method as described in any one or more of the examples in this section, wherein the characteristics of the respective heterogeneous energy storage devices include energy storage device chemistries and physical features of the respective heterogeneous energy storage devices.

### EXAMPLE 20

The method as described in any one or more of the examples in this section, further comprising receiving updates of SOC estimation parameters from the operating system of the computing device and updating the SOC estimation parameters stored by the power management controller accordingly.

### CONCLUSION

Although the example implementations have been described in language specific to structural features and/or methodological acts, it is to be understood that the implementations defined in the appended claims are not necessarily limited to the specific features or acts described. Rather, the specific features and acts are disclosed as example forms of implementing the claimed features.

1. A client computing device powered at least in part by energy storage devices, the client computing device comprising:
two or more heterogeneous energy storage devices included with the client computing device;
a fuel gauge included in the client computing device and attached to the two or more energy storage devices, the fuel gauge including:
storage to maintain state of charge (SOC) estimation parameters for each of the energy storage devices attached to the fuel gauge, each of the SOC estimation parameters corresponding to characteristics of the respective energy storage devices;
a controller connected via shared circuitry to each of the energy storage devices attached to the fuel gauge, the controller operable to:
measure values indicative of a status of each of the energy storage devices attached to the fuel gauge; and
update status information corresponding to each of the energy storage devices attached to the fuel gauge based on the measured values and the SOC estimation parameters.

2. The client computing device of claim 1, wherein the controller of the fuel gauge includes shared voltage measuring circuitry configured to periodically measure the terminal voltage of the attached energy storage devices by time multiplexing.

3. The client computing device of claim 1, wherein the controller of the fuel gauge includes shared current measurement circuitry configured to periodically measure current flowing into or out of the attached energy storage devices by time multiplexing.

4. The client computing device of claim 1, wherein the controller is a single microcontroller.

5. The client computing device of claim 1, wherein the controller is a single sequential logic circuit.

6. The client computing device of claim 1, wherein the fuel gauge includes a communication interface operable to communicate the status information to a power management system of the client computing device.

7. The client computing device of claim 6, wherein the power management system is operable to output a user interface containing the status information of the power management system, the user interface configured to expose combined status for the two or more energy storage devices and individual statuses of the two or more energy storage devices.

8. The client computing device of claim 1, wherein the characteristics of the respective energy storage devices include energy storage device chemistries and physical features of the respective energy storage devices.

9. The client computing device of claim 1, wherein the status information comprises a SOC value, cycle count, estimated internal resistance, and estimated capacity of each of the energy storage devices attached to the fuel gauge.

10. The client computing device of claim 1, wherein the fuel gauge is configured to receive updates of SOC estimation parameters from an operating system of the client computing device.

11. A method implemented by a computing device having two or more heterogeneous energy storage devices and a multiple energy storage device fuel gauge designed with shared measuring circuitry connected to the two or more heterogeneous energy storage devices, the method comprising:
receiving data measured via the shared measuring circuitry of the multiple energy storage device fuel gauge corresponding to at least voltage and current of the two or more heterogeneous energy storage devices, the received data corresponding to the voltage comprises voltage data measured via shared voltage measuring circuitry of the multiple energy storage device fuel gauge configured to periodically measure the terminal voltage of the attached heterogeneous energy storage devices by time multiplexing;
computing one or more status values based on state of charge (SOC) estimation parameters for each of the heterogeneous energy storage devices and the received data corresponding to voltage and current of the two or more heterogeneous energy storage devices, the SOC estimation parameters corresponding to characteristics of the respective heterogeneous energy storage devices that are correlated to the received data to derive the one or more status values; and
updating status information corresponding to each of the heterogeneous energy storage devices with the one or more status values as computed.

12. (canceled)

13. The method of claim 11, wherein receiving the data comprises receiving current data measured via shared current measurement circuitry of the multiple energy storage device fuel gauge configured to periodically measure current flowing into or out of the attached heterogeneous energy storage devices by time multiplexing.

14. The method of claim 11, further comprising receiving data measured via the shared measuring circuitry of the multiple energy storage device fuel gauge corresponding to a number of executed charging events and discharging events of the respective heterogeneous energy storage devices.

15. The method of claim 11, wherein the status information comprises SOC values, internal resistance, and aging compensated capacity for each of the heterogeneous energy storage devices.

16. The method of claim 11, wherein the receiving, computing, and updating are performed by an operating system executed by the computing device in communication with a single microcontroller of the computing device that implements the multiple energy storage device fuel gauge.

17. The method of claim 11, further comprising exposing the status information for the multiple heterogeneous energy storage devices to other components of the computing device via an application programming interface (API) to facilitate power management actions based on the one or more status values.

18. A method implemented by a power management controller of a client computing device that includes a multiple energy storage device fuel gauge, the method comprising:
storing state of charge (SOC) estimation parameters for two or more heterogeneous energy storage devices included with the client computing device, each of the SOC estimation parameters corresponding to characteristics of the respective heterogeneous energy storage devices;
measuring via shared measuring circuitry of the multiple energy storage device fuel gauge at least voltage and current of the two or more heterogeneous energy storage devices;
computing status values by correlating the SOC estimation parameters with the measured voltage and current of the two or more heterogeneous energy storage devices to derive status values including at least a SOC for each energy storage device and internal resistance for each energy storage device based on measured voltage and current values;
updating status information corresponding to each of the heterogeneous energy storage devices to reflect the computed status values; and
communicating the updated status information via a shared communication channel to an operating system of the client computing device to facilitate power management operations by the operating system.

19. The method of claim 18, wherein the characteristics of the respective heterogeneous energy storage devices include energy storage device chemistries and physical features of the respective heterogeneous energy storage devices.

20. The method of claim 18, further comprising receiving updates of SOC estimation parameters from the operating system of the client computing device and updating the SOC estimation parameters stored by the power management controller accordingly.

21. The method of claim 18, further comprising outputting a user interface containing the status information of the power management controller, the user interface configured to display a combined status for the two or more energy storage devices and individual statuses of the two or more energy storage devices.
